(19) United States
(12) Patent Application Publication
(10) Pub. No.: US 2012/0312326 A1
(43) Pub. Date: Dec. 13, 2012

(54) METHODS FOR CLEANING A SURFACE OF A SUBSTRATE USING A HOT WIRE CHEMICAL VAPOR DEPOSITION (HWCVD) CHAMBER

(75) Inventors: SUKTI CHATTERJEE, Cupertino, CA (US); JEONGWON PARK, Palo Alto, CA (US)

(73) Assignee: APPLIED MATERIALS, INC., Santa Clara, CA (US)

(21) Appl. No.: 13/488,851

(22) Filed: Jun. 5, 2012

Related U.S. Application Data
(60) Provisional application No. 61/495,728, filed on Jun. 10, 2011.

(51) Int. Cl. B08B 7/04; B08B 5/00

(52) U.S. Cl. 134/19; 134/31

(57) ABSTRACT

Methods for cleaning a surface of a substrate using a hot wire chemical vapor deposition (HWCVD) chamber are provided herein. In some embodiments, a method for cleaning a surface of a substrate may include providing a substrate having a material disposed on a surface of the substrate to a hot wire chemical vapor deposition (HWCVD) chamber; providing hydrogen (H₂) gas to the HWCVD chamber; heating one or more filaments disposed in the HWCVD chamber to a temperature sufficient to dissociate the hydrogen (H₂) gas; and exposing the substrate to the dissociated hydrogen (H₂) gas to remove at least some of the material from the surface of the substrate.

### CROSS-REFERENCE TO RELATED APPLICATIONS

This application claims benefit of U.S. provisional patent application Ser. No. 61/495,728, filed Jun. 10, 2011, which is herein incorporated by reference.

### FIELD

Embodiments of the present invention generally relate to semiconductor substrate processing.

### BACKGROUND

In deposition processes, for example, such as epitaxial growth processes, a clean and/or contaminant free surface is desired to allow a uniform layer having a desired composition to be deposited. In order to provide the clean and/or contaminant free surface, a cleaning process is performed. For example, a conventional substrate cleaning process to remove oxygen or carbon containing contaminant layers typically includes producing an atomic hydrogen source by heating a tantalum (Ta) tube disposed within a process chamber to a temperature of greater than about 1600 degrees Celsius to dissociate hydrogen (H₂) adsorbed on surfaces of the tube. However, due to the high temperatures required to dissociate the hydrogen (H₂), the inventors have observed that such processes are time and energy consuming.

Therefore, the inventors have provided improved methods of cleaning a surface of a substrate using a hot wire chemical vapor deposition (HWCVD) chamber.

### SUMMARY

Methods for cleaning a surface of a substrate using a hot wire chemical vapor deposition (HWCVD) chamber are provided herein. In some embodiments, a method for cleaning a surface of a substrate may include providing a substrate having a material disposed on a surface of the substrate to a hot wire chemical vapor deposition (HWCVD) chamber; providing hydrogen (H₂) gas to the HWCVD chamber; heating one or more filaments disposed in the HWCVD chamber to a temperature sufficient to dissociate the hydrogen (H₂) gas; and exposing the substrate to the dissociated hydrogen (H₂) gas to remove at least some of the material from the surface of the substrate.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram of a method for cleaning a surface of a substrate using a hot wire chemical vapor deposition (HWCVD) chamber in accordance with some embodiments of the present invention.

FIGS. 2A-B are illustrative cross-sectional views of a substrate during different stages of the processing sequence of FIG. 1 in accordance with some embodiments of the present invention.

FIG. 3 is a HWCVD chamber suitable for performing the methods depicted in FIG. 1 in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention provide methods for cleaning a surface of a substrate using a hot wire chemical vapor deposition (HWCVD) chamber. The inventive methods may advantageously provide methods of cleaning a substrate surface (e.g., removal of surface contaminants, oxide layers, carbide layers, or the like) that is more efficient and less time consuming than conventional substrate cleaning processes.

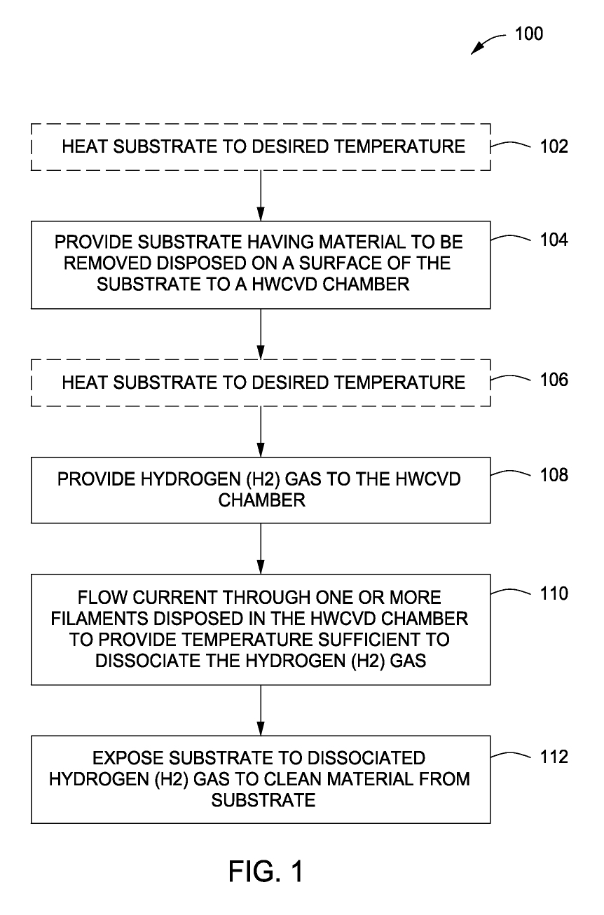

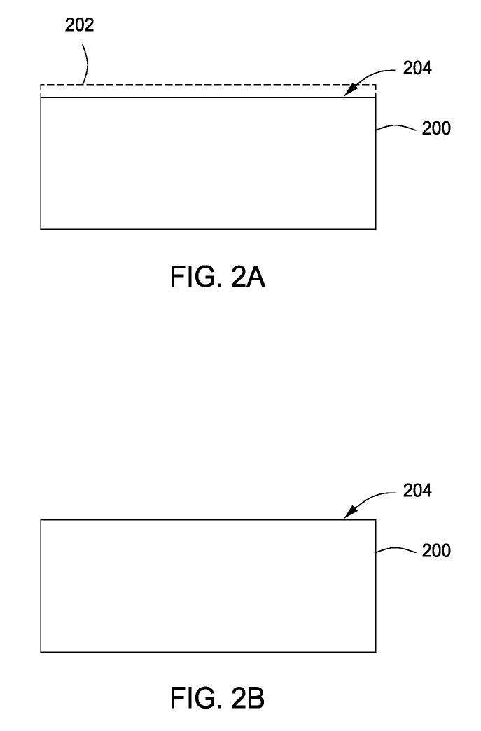

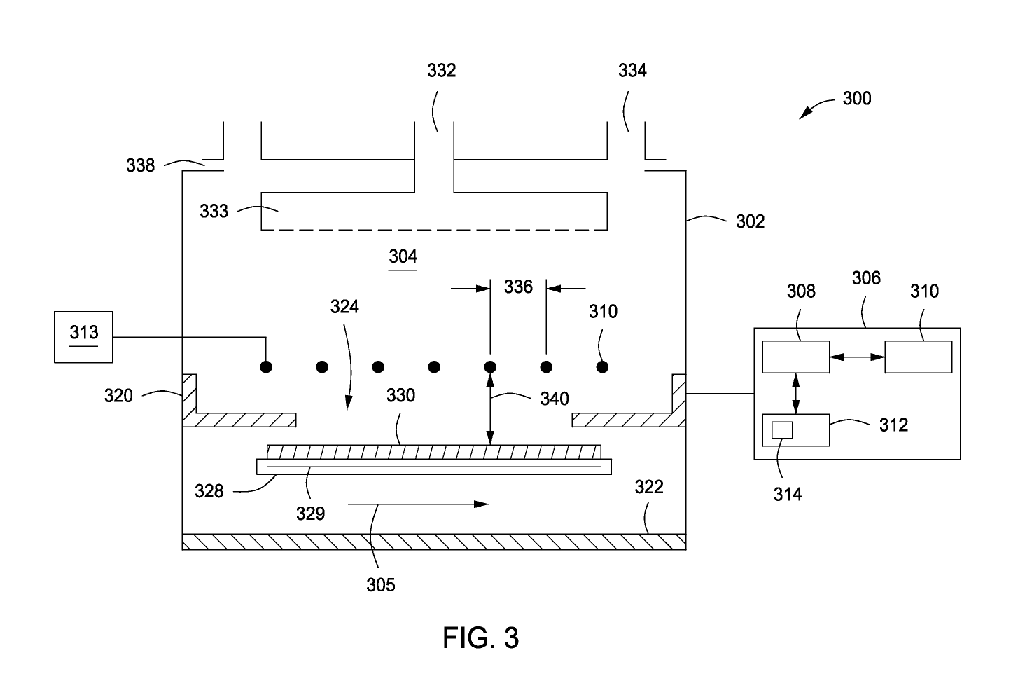

FIG. 1 is a flow diagram of a method 100 for cleaning a surface of a substrate using a hot wire chemical vapor deposition (HWCVD) chamber in accordance with some embodiments of the present invention. FIGS. 2A-B are illustrative cross-sectional views of the substrate during different stages of the processing sequence of FIG. 1 in accordance with some embodiments of the present invention. The inventive methods may be performed in any HWCVD chamber suitable for processing semiconductor substrates in accordance with embodiments of the present invention, such as the HWCVD chamber discussed below with respect to FIG. 3.

The method 100 generally begins at 102 where a substrate (e.g., substrate 200) may be optionally heated to a desired temperature. The desired temperature may be any temperature, for example, such as about room temperature (e.g., about 20-25 degrees Celsius) to about 1000 degrees Celsius. Heating the substrate 200 prior to performing a cleaning process (e.g. the cleaning of a surface of the substrate 200 described below) may facilitate a de-gassing and/or removal of some contaminants from the substrate 200. Moreover, heating the substrate 200 prior to performing the cleaning process may provide at least a portion of the energy needed to facilitate removal of materials or one or more layers (e.g. layer 202 described below) disposed on the substrate to clean the substrate 200, thus reducing the amount of energy needed to be provided by the HWCVD chamber. In some embodiments, the substrate 200 may be heated in the chamber used to perform the cleaning process (e.g., the HWCVD chamber 300 described below). In some embodiments, the substrate 200 may be heated in a different chamber than that used to perform the cleaning process (e.g., the HWCVD chamber 300 described below). In embodiments where the substrate 200 is heated in a different chamber, the incidence of contamination of the HWCVD chamber with materials from the substrate may be reduced.

In embodiments where the substrate is heated in a different chamber than that used to perform the cleaning process the chamber may be any type of chamber suitable to heat the substrate 200 to the desired temperature, for example such as an annealing chamber, deposition chamber, or the like. In some embodiments the chamber may be a HWCVD chamber such as the HWCVD chamber described below with respect to FIG. 3. In some embodiments, the chamber may be one or a plurality of chambers coupled to a multi-chamber tool, for example such as a cluster tool or an in-line HWCVD tool, such as that described in US patent application publication 2011/0104848, published on May 5, 2011, to Dieter Haas, et al., and assigned to the assignee of the present invention.

Referring to FIG. 2A, the substrate 200 may be any suitable substrate, such as a doped or un-doped silicon substrate, a III-V compound substrate, a II-VI compound substrate, a silicon germanium (SiGe) substrate, an epi-substrate, a silicon-on-insulator (SOI) substrate, a display substrate such as a liquid crystal display (LCD), a plasma display, an electro luminescence (EL) lamp display, a light emitting diode (LED) substrate, a solar cell array, solar panel, or the like. In some embodiments, the substrate 200 may be a semiconductor wafer, such as a 200 or 300 mm semiconductor wafer. In some embodiments, the substrate 200 may be a large scale LCD or glass substrate, for example, such as an about 1000 mm×1250 mm substrate or an about 2200 mm×2500 mm substrate.

In some embodiments, the substrate 200 may comprise one or more layers, for example, oxide layers, nitride layers, high or low K dielectric layers, conductive layers, or the like. Alternatively or in combination, in some embodiments, one or more features (e.g., a via, a trench, a dual damascene structure, or the like) may be formed in or on the substrate 200 and/or one or more layers formed thereon. The features may be formed via any suitable process, for example such as an etch process. In addition, the substrate 200 may undergo additional processing prior to preheating, such as a wet chemical cleaning process, or the like.

In some embodiments, the substrate 200 may comprise a material disposed on the surface 204 of the substrate 200 that is to be removed. In some embodiments, the material to be removed may form a layer 202 disposed on the surface 204 of the substrate 200. The layer 202 may be any type of layer requiring such removal. For example, in some embodiments, the layer 202 may comprise carbon, for example such as a carbide layer. Alternatively, the layer 202 may comprise oxygen, for example an oxide layer such as surface oxide or native oxide layer comprising silicon oxide (SiO₂), titanium oxide (TiO₂), nickel oxide (NiO₂), or the like. The layer 202 may have a thickness of, for example about 1 to about 2 nanometers.

At 104, the substrate 200 is provided to a hot wire chemical vapor deposition (HWCVD) chamber. The HWCVD chamber may be any HWCVD chamber suitable for processing semiconductor substrates, such as the HWCVD chamber discussed below with respect to FIG. 3. In embodiments where the substrate 200 is heated prior to providing the substrate 200 to the HWCVD chamber (i.e., discussed above at 102), the substrate 200 may be transferred via any means suitable to transfer the substrate 200 while minimizing the loss of heat from the substrate 200. In some embodiments, for example where the HWCVD chamber is part of a cluster tool, the substrate 200 may be transferred via a transfer robot disposed in a transfer chamber. Alternatively, in some embodiments, for example where the HWCVD chamber is part of an inline tool, the substrate 200 may be transferred via a linear conveyor directly from the preheat chamber to the HWCVD chamber or through a separation chamber disposed between the preheat chamber and the HWCVD chamber.

At 106, the substrate 200 may be optionally heated to a desired temperature while in the HWCVD chamber. The optional heating at 106 may be performed in addition to or alternative to the optional heating described above at 102. Further, the optional heating at 106 may be performed prior to or concurrently with the cleaning process as described below. The substrate 200 may be heated to any temperature, for example influenced by an amount of energy required to facilitate removal of the materials or layer 202. For example, the desired temperature may be about room temperature (e.g., about 20-25 degrees Celsius) to about 1000 degrees Celsius. The substrate 200 may be heated via any suitable mechanism, for example such as a substrate heater embedded in a substrate support of the HWCVD chamber (e.g., heater 329 of substrate support 328 described below), or one or more filaments (e.g., filaments or wires 310 described below) disposed in the HWCVD chamber. Heating the substrate 200 prior to performing a cleaning process (e.g. the cleaning of a surface of the substrate 200 described below) may provide at least a portion of the energy needed to facilitate removal of one or more layers (e.g. layer 202 described below) disposed on the substrate to clean the substrate 200, thus reducing the time of exposure and amount of hydrogen gas needed to be provided by the HWCVD chamber.

Next, at 108, a hydrogen (H₂) gas may be provided to the HWCVD chamber. The hydrogen (H₂) gas may be provided to the HWCVD chamber at any suitable flow rate, for example such as about 50 to about 700 sccm (for example, for a 300 mm wafer process chamber). The flow rates provided herein may vary depending upon the size of the substrate being cleaned and/or of the processing volume of the HWCVD chamber. In some embodiments, the hydrogen (H₂) gas may be diluted, for example, with an inert gas such as helium (He), argon (Ar), or the like. The ratio of hydrogen (H₂) gas to inert gas may be any ratio, for example such as about 1:9 to about 9:1. The ratio may be adjusted to provide an amount of hydrogen (H₂) necessary to produce a needed amount of energy (when dissociated) to facilitate removal of the layer 202, as discussed below.

In embodiments where the hydrogen (H₂) gas is diluted, the hydrogen (H₂) gas and inert gas may be mixed prior to providing the gases to the HWCVD chamber (e.g., mixed prior to providing the hydrogen (H₂) gas and inert gas mixture to the inlet 332 and/or showerhead 333 described below). Alternatively, in some embodiments, the hydrogen (H₂) gas and inert gas may be co-flowed into the HWCVD chamber via two independent gas supplies and mixed within the HWCVD chamber (e.g., in the internal processing volume 304 discussed below).

At 110, a current is provided to one or more filaments disposed in the HWCVD chamber to heat the filaments to a temperature sufficient to dissociate the hydrogen (H₂) gas. The one or more filaments may be any type of filaments disposed in any type of HWCVD chamber, for example such as the plurality of filaments disposed in the HWCVD chamber described below with respect to FIG. 3. The temperature may be any temperature suitable to cause disassociation of the hydrogen (H₂) gas and, further, to provide a suitable amount of energy needed to remove the desired material, or layer 202, for example, such as about 1000 to about 2400 degrees Celsius. In some embodiments, the temperature may be at least in part dictated by the composition of the layer 202 and, thus, the activation energy of a reaction between the dissociated gas and the layer 202 and/or the amount of energy needed to break the chemical bonds of the layer 202 compounds, thus facilitating removal of the material, or layer 202. For example, in embodiments where the layer 202 comprises silicon oxide (SiO₂), a reaction between the dissociated hydrogen atoms may be represented as follows:

2H*(g)+SiO₂(s)=SiO(g)+H₂O(g)

In such embodiments, the temperature required to facilitate the above reaction may be greater than about 700 degrees Celsius, or in some embodiments, about 750 degrees Celsius.

Next, at 112, the surface 204 of the substrate 200 is cleaned by exposing the substrate 200 to the dissociated hydrogen (H₂) gas. By exposing the substrate 200 to the dissociated hydrogen (H₂) gas, hydrogen atoms react with the material disposed on the surface of the substrate (such as the layer 202), thereby facilitating removal of the materials or layer 202, thus cleaning the surface 204 of the substrate 200. For example, in embodiments where the layer comprises an oxide (e.g., a native oxide layer), the hydrogen atoms react with the oxide causing an oxide reduction and volatile products form, namely molecules of elements or hydrides of the elements and/or lower oxides. For example, in embodiments where the oxide layer comprises silicon oxide (SiO₂), the volatile products of the reactions may be water (H₂O) and hydrides of silicon (Si) and carbon (C). In some embodiments, in addition to the reaction between the hydrogen atoms and the materials or the layer 202, the atomic hydrogen may further react with the surface 204 of the substrate 200, thus forming volatile products of the surface 204 material, thereby causing the surface 204 of the substrate 200 to be etched. For example, in embodiments where the substrate 200 comprises a gallium arsenide (GaAs), volatile products hydrides of arsenic (As) and gallium (Ga) may be produced.

The substrate 200 may be exposed to dissociated hydrogen (H₂) gas for any amount of time suitable to facilitate removal of the layer 202. For example, in some embodiments, the substrate may be exposed to the dissociated hydrogen (H₂) gas for about 10 to about 300 seconds, or in some embodiments, less than about one minute.

To facilitate removal of the materials or the layer 202 the substrate 200 may be positioned under a HWCVD source (e.g., the filaments or wires 310 described below with respect to FIG. 3) such that the substrate 200 is exposed to the hydrogen gas and decomposed species thereof. The substrate 200 may be positioned under the HWCVD source on a substrate support (e.g., substrate support 328 described below with respect to FIG. 3) in a static position or, in some embodiments, dynamically to facilitate cleaning as the substrate 200 passes under the HWCVD source.

In addition to the above, additional process parameters may be utilized to facilitate removal of the layer 202 from the substrate 200 and may be dictated in at least part by the amount of energy needed to remove the layer 202. For example, in some embodiments, the process chamber may be maintained at a pressure of about 10 to about 500 mTorr, or, in some embodiments, about 100 mTorr (for example, for a 300 mm wafer process chamber). The chamber pressures provided herein may vary depending upon the size of the substrate being cleaned and/or of the processing volume of the HWCVD chamber. Alternatively, or in combination, in some embodiments, the physical parameters of the HWCVD chamber (e.g., filament diameter, filament to filament distance 336, or filament to substrate distance 340 described below) may be adjusted to facilitate removal of the layer 202 from the substrate 200.

In any of the above embodiments, any of the process parameters (e.g., flow rate of hydrogen (H₂) gas, ratio of hydrogen gas (H₂) to inert gas, substrate temperature, filament temperature, additional process parameters, physical parameters of the HWCVD chamber, or the like) may be adjusted with respect to each other to provide the amount of energy needed to facilitate removal of the layer 202, for example such as the activation energy of a reaction between the dissociated gas and the layer 202 and/or the amount of energy needed to break the chemical bonds of the layer 202 compounds, thus facilitating removal of the layer 202.

After cleaning the surface 204 of the substrate 200 at 110, the method 100 generally ends and the substrate 200 may proceed for further processing. In some embodiments, additional processes such as additional layer depositions, etching, annealing, or the like, may be performed on the substrate 200, for example, to form a semiconductor device on the substrate 200 or to prepare the substrate 200 for use in applications such as photovoltaic cells (PV), light emitting diodes (LED), or displays (e.g., liquid crystal display (LCD), plasma display, electro luminescence (EL) lamp display, or the like).

FIG. 3 depicts a schematic side view of a HWCVD process chamber 300 suitable for use in accordance with embodiments of the present invention. The process chamber 300 generally comprises a chamber body 302 having an internal processing volume 304. A plurality of filaments, or wires 310, are disposed within the chamber body 302 (e.g., within the internal processing volume 304). The plurality of wires 310 may also be a single wire routed back and forth across the internal processing volume 304. The plurality of wires 310 comprise a HWCVD source. The wires 310 may comprise any suitable conductive material, for example, such tungsten, tantalum, iridium, nickel-chrome, palladium, or the like. The wires 310 may comprise any thickness suitable to provide a desired temperature to facilitate a process in the process chamber 300. For example, in some embodiments, each wire 310 may comprise a diameter of about 0.2 to about 1 mm, or in some embodiments, about 0.5 mm.

Each wire 310 is clamped in place by support structures (not shown) to keep the wire taught when heated to high temperature, and to provide electrical contact to the wire. In some embodiments, a distance between each wire 310 (i.e., the wire to wire distance 336) may be varied to provide a desired temperature profile within the process chamber 300. For example, in some embodiments, the wire to wire distance 336 may be about 10 to about 120 mm, or in some embodiments about 20 mm, or in some embodiments, about 60 mm.

A power supply 313 is coupled to the wire 310 to provide current to heat the wire 310. A substrate 330 (e.g., substrate 200 described above) may be positioned under the HWCVD source (e.g., the wires 310), for example, on a substrate support 328. The substrate support 328 may be stationary for static deposition, or may move (as shown by arrow 305) for dynamic deposition as the substrate 330 passes under the HWCVD source. In some embodiments, the substrate support 328 may comprise a heater 329 embedded in the substrate support to facilitate controlling a temperature of the substrate 200. The heater 329 may be any type of heater, for example, such as a resistive heater.

In some embodiments, a distance between each wire 310 and the substrate 330 (i.e., the wire to substrate distance 340) may be varied to facilitate a particular process being performed in the process chamber 300. For example, in some embodiments, the wire to substrate distance 340 may be about 20 to about 120 mm, or in some embodiments about 45 mm, or in some embodiments, about 60 mm.

The chamber body 302 further includes one or more gas inlets (one gas inlet 332 shown) to provide one or more process gases and one or more outlets (two outlets 334 shown) to a vacuum pump to maintain a suitable operating pressure within the process chamber 300 and to remove excess process gases and/or process byproducts. The gas inlet 332 may feed into a shower head 333 (as shown), or other suitable gas distribution element, to distribute the gas uniformly, or as desired, over the wires 310.

In some embodiments, one or more shields 320 may be provided, for example between the wires and a substrate, and may define an opening 324 that defines the deposition area for the substrate and may reduce unwanted deposition on interior surfaces of the chamber body 302. Alternatively or in combination, one or more chamber liners 322 can be used to make cleaning easier. The use of shields, and liners, may preclude or reduce the use of undesirable cleaning gases, such as the greenhouse gas NF₃. The shields 320 and chamber liners 322 generally protect the interior surfaces of the chamber body from undesirably collecting deposited materials due to the process gases flowing in the chamber. The shields 320 and chamber liners 322 may be removable, replaceable, and/or cleanable. The shields 320 and chamber liners 322 may be configured to cover every area of the chamber body that could become coated, including but not limited to, around the wires 310 and on all walls of the coating compartment. Typically, the shields 320 and chamber liners 322 may be fabricated from aluminum (Al) and may have a roughened surface to enhance adhesion of deposited materials (to prevent flaking off of deposited material). The shields 320 and chamber liners 322 may be mounted in the desired areas of the process chamber, such as around the HWCVD sources, in any suitable manner. In some embodiments, the source, shields, and liners may be removed for maintenance and cleaning by opening an upper portion of the deposition chamber. For example, in some embodiments, the a lid, or ceiling, of the deposition chamber may be coupled to the body of the deposition chamber along a flange 338 that supports the lid and provides a surface to secure the lid to the body of the deposition chamber.

A controller 306 may be coupled to various components of the process chamber 300 to control the operation thereof. Although schematically shown coupled to the process chamber 300, the controller may be operably connected to any component that may be controlled by the controller, such as the power supply 312, a gas supply (not shown) coupled to the inlet 332, a vacuum pump and or throttle valve (not shown) coupled to the outlet 334, the substrate support 328, and the like, in order to control the HWCVD deposition process in accordance with the methods disclosed herein. The controller 306 generally comprises a central processing unit (CPU) 308, a memory 312, and support circuits 316 for the CPU 308. The controller 306 may control the HWCVD process chamber 300 directly, or via other computers or controllers (not shown) associated with particular support system components. The controller 306 may be one of any form of general-purpose computer processor that can be used in an industrial setting for controlling various chambers and sub-processors. The memory, or computer-readable medium, 312 of the CPU 308 may be one or more of readily available memory such as random access memory (RAM), read only memory (ROM), floppy disk, hard disk, flash, or any other form of digital storage, local or remote. The support circuits 316 are coupled to the CPU 308 for supporting the processor in a conventional manner. These circuits include cache, power supplies, clock circuits, input/output circuitry and subsystems, and the like. Inventive methods as described herein may be stored in the memory 312 as software routine 314 that may be executed or invoked to turn the controller into a specific purpose controller to control the operation of the process chamber 300 in the manner described herein. The software routine may also be stored and/or executed by a second CPU (not shown) that is remotely located from the hardware being controlled by the CPU 308.

Thus, methods for cleaning a surface of a substrate using a hot wire chemical vapor deposition (HWCVD) chamber are provided herein. The inventive methods may advantageously provide methods of cleaning a substrate surface (e.g., removal of oxide layers, carbide layers, or the like) that is more efficient and less time consuming than conventional substrate cleaning processes.

While the foregoing is directed to embodiments of the present invention, other and further embodiments of the invention may be devised without departing from the basic scope thereof.

1. A method for cleaning a surface of a substrate, comprising:
providing a substrate having a material disposed on a surface of the substrate to a hot wire chemical vapor deposition (HWCVD) chamber;
providing hydrogen (H₂) gas to the HWCVD chamber;
heating one or more filaments disposed in the HWCVD chamber to a temperature sufficient to dissociate the hydrogen (H₂) gas; and
exposing the substrate to the dissociated hydrogen (H₂) gas to remove at least some of the material from the surface of the substrate.

2. The method of claim 1, wherein providing the hydrogen (H₂) gas to the HWCVD chamber comprises:
diluting the hydrogen (H₂) gas with an inert gas.

3. The method of claim 2, wherein diluting the hydrogen (H₂) gas with an inert gas comprises providing a ratio of the hydrogen (H₂) to the inert gas of about 1:9 to about 9:1.

4. The method of claim 2, wherein the inert gas is one of argon (Ar) or helium (He).

5. The method of claim 2, wherein diluting the hydrogen (H₂) gas comprises:
mixing the hydrogen (H₂) gas and the inert gas; and
providing the mixture of the hydrogen (H₂) gas and the inert gas to the HWCVD chamber.

6. The method of claim 2, wherein diluting the hydrogen (H₂) gas comprises:
co-flowing the hydrogen (H₂) gas and the inert gas to the HWCVD chamber.

7. The method of claim 1, further comprising:
heating the substrate to a desired temperature prior to providing the substrate to the HWCVD chamber.

8. The method of claim 1, wherein the desired temperature is about 20 to about 1000 degrees Celsius.

9. The method of claim 1, further comprising:
heating the substrate to a desired temperature after providing the substrate to the HWCVD chamber and prior to providing the hydrogen (H₂) gas to the HWCVD chamber.

10. The method of claim 9, wherein the desired temperature is about 20 to about 1000 degrees Celsius.

11. The method of claim 1, wherein the one or more filaments comprise a plurality of filaments, and wherein each of the plurality of filaments are disposed about 10 to about 120 mm from another adjacent filament.

12. The method of claim 1, wherein the one or more filaments are disposed about 20 to about 120 mm above the substrate.

13. The method of claim 1, wherein the one or more filaments have a diameter of about 0.2 to about 1 mm.

14. The method of claim 1, wherein the temperature is about 1000 to about 2400 degrees Celsius.

15. The method of claim 1, wherein exposing the substrate to dissociated hydrogen (H₂) gas to remove the layer comprises exposing the substrate to dissociated hydrogen (H₂) gas for about 10 to about 300 seconds.

16. The method of claim 1, wherein the HWCVD chamber is maintained at a pressure of about 10 to about 500 mTorr while depositing the material atop the substrate.

17. The method of claim 1, wherein the layer comprises one of carbon or oxygen.

18. The method of claim 1, wherein the layer has a thickness of about 1 to about 2 nanometers.

19. The method of claim 1, further comprising:
heating the substrate while cleaning the surface of the substrate.

20. The method of claim 19, wherein heating the substrate comprises heating the substrate to a temperature of about 20 to about 1000 degrees Celsius.
